(19) United States
(12) Patent Application Publication
(10) Pub. No.: US 2022/0107430 A1
(43) Pub. Date: Apr. 7, 2022

(54) COMPUTED TOMOGRAPHY (CT) DETECTOR COMPRISING A CONVERTER FOR CONVERTING HIGH ENERGY X-RAYS INTO ELECTRONS THAT ESCAPE FROM THE CONVERTER AND APPARATUS AND METHOD FOR DETECTING THE ESCAPED ELECTRONS

(71) Applicant: Photo Diagnostic Systems, Inc., Boxboro, MA (US)

(72) Inventor: Olof Johnson, Westminster, MA (US)

(21) Appl. No.: 17/496,475

(22) Filed: Oct. 7, 2021

Related U.S. Application Data
(60) Provisional application No. 63/088,654, filed on Oct. 7, 2020.

(51) Int. Cl. G01T 1/20

(52) U.S. Cl. CPC G01T 1/2018; G01T 1/2002

(57) ABSTRACT

A detector for detecting X-rays passing through an object being scanned, the detector comprising: a converter configured to convert X-rays into electrons; a scintillator configured to detect electrons from the converter and produce light in proportion to the electrons detected; and a photodetector configured to convert the light produced by the scintillator into electrical current.

### REFERENCE TO PENDING PRIOR PATENT APPLICATION

This patent application claims benefit of pending prior U.S. Provisional Patent Application Ser. No. 63/088,654, filed Oct. 7, 2020 by Photo Diagnostic Systems, Inc. and Olof Johnson for COMPUTED TOMOGRAPHY (CT) DETECTOR COMPRISING CONVERTER FOR CONVERTING HIGH ENERGY X-RAYS INTO ELECTRONS THAT ESCAPE FROM THE CONVERTER AND USING A SCINTILLATOR AND PHOTODETECTOR TO DETECT THE ESCAPED ELECTRONS (Attorney's Docket No. PDSI-8 PROV).

The above-identified patent application is hereby incorporated herein by reference.

### FIELD OF THE INVENTION

This invention relates to imaging systems in general, and more particularly to computed tomography (CT) imaging systems, and even more particularly to detectors for CT imaging systems.

### BACKGROUND OF THE INVENTION

In many situations it can be desirable to image the interior of an object. By way of example but not limitation, in the medical field, it can be desirable to image the interior of a patient's body so as to allow viewing of internal structures without physically penetrating the skin. By way of further example but not limitation, in the security field, it can be desirable to image the interior of a container (e.g., a suitcase, a package, etc.) so as to allow viewing of internal structures without physically opening the container. By way of still further example but not limitation, in the manufacturing field, it can be desirable to image the interior of a manufactured article (e.g., the solid stage of a rocket) so as to allow viewing of internal structures without physically opening the article.

### CT Systems in General

Computed tomography (CT) has emerged as a key imaging modality in the medical, security and manufacturing fields, among others. CT imaging systems generally operate by directing X-rays into an object (e.g., a body or a container or manufactured article) from a variety of positions, detecting the X-rays passing through the object, and then processing the detected X-rays so as to build a three-dimensional (3D) data set, and a 3D computer model, of the interior of the object (e.g., a patient's anatomy or the contents of a container or the interior of a manufactured article). The 3D data set and 3D computer model can then be visualized so as to provide images (e.g., slice images, 3D computer images, etc.) of the interior of the object (e.g., the patient's anatomy or the contents of the container or the interior of the manufactured article).

By way of example but not limitation, and looking now at FIGS. 1 and 2, there is shown an exemplary CT imaging system 5. CT imaging system 5 generally comprises a torus 10 which is supported by a base 15. A center opening 20 is formed in torus 10. Center opening 20 receives the object (e.g., the anatomy or the container or the manufactured article) which is to be scanned by CT imaging system 5.

Looking next at FIG. 3, torus 10 generally comprises a fixed gantry 25, a rotating disc 30, an X-ray tube assembly 35 and an X-ray detector assembly 40. More particularly, fixed gantry 25 is disposed concentrically about center opening 20. Rotating disc 30 is rotatably mounted to fixed gantry 25. X-ray tube assembly 35 and X-ray detector assembly 40 are mounted to rotating disc 30 in diametrically-opposed relation, such that an X-ray beam 45 (generated by X-ray tube assembly 35 and detected by X-ray detector assembly 40) is passed through the object (e.g., the body or the container or the manufactured article) disposed in center opening 20. Inasmuch as X-ray tube assembly 35 and X-ray detector assembly 40 are mounted on rotating disc 30 so that they are rotated concentrically about center opening 20, X-ray beam 45 will be passed through the object (e.g., the body or the container or the manufactured article) along a full range of radial positions, so as to enable CT imaging system 5 to create a “slice” image of the object penetrated by the X-ray beam. Furthermore, by moving the object (e.g., the body or the container or manufactured article) and/or CT imaging system 5 relative to one another during scanning, a series of slice images can be acquired, and thereafter appropriately processed, so as to create a 3D data set of the scanned object and a 3D computer model of the scanned object.

In practice, it is now common to effect helical scanning of the object so as to generate a 3D data set of the scanned object, which can then be processed to build a 3D computer model of the scanned object. The 3D data set and/or 3D computer model can then be visualized so as to provide images (e.g., slice images, 3D computer images, etc.) of the interior of the object (e.g., the patient's anatomy or the contents of the container or the interior of the manufactured article).

### The X-Ray Detector Assembly

The X-ray detector assembly of a CT imaging system (e.g., the X-ray detector assembly 40 of the aforementioned CT imaging system 5) measures the amount of X-rays which pass through the object being scanned. The X-ray detector assembly typically comprises an array of individual detectors 50. See FIG. 4. Each of the detectors in the array separately reports the amount of X-rays received by that detector, which data is then appropriately processed so as to create a 3D data set of the scanned object and a 3D computer model of the scanned object.

Looking now at FIG. 5, each of the individual CT detectors 50 generally comprise a scintillator element 55 and a photodiode element 60 (i.e., a photodetector). Scintillator element 55 is configured to convert incoming X-rays into light, and photodiode element 60 converts this light into electrical current 65. It will be appreciated that the electrical current 65 provided by photodiode element 60 is thus representative of the amount of X-rays received by scintillator element 55 of detector 50.

At the typical X-ray energy used for CT (e.g., 80-140 keV peak), the photons in the emitted X-ray beam have a high probability of interacting in scintillator element 55 in such a way (e.g., via Compton scatter or photocapture) so as to deposit enough energy in scintillator element 55 to generate light. This light generated in scintillator element 55 is then detected by photodiode element 60.

Higher energy X-rays (i.e., X-rays having an energy greater than approximately 140 keV) are typically used to image larger and more dense objects. This can be particularly important in the security and manufacturing fields, where large, dense objects (e.g., the solid stage of a rocket) may require scanning.

As X-ray energy is increased, the probability of interactions between the X-rays and scintillator element 55 decreases, and thus the detector either suffers from low efficiency, or the scintillator element 55 must be made thicker in order to maintain efficiency.

However, as scintillator element 55 is made thicker to compensate for the higher X-ray energy, a new problem emerges: the X-rays are more likely to interact by Compton scattering and less likely to interact by photocapture. In Compton scattering, the scattered X-rays may interact in adjacent detectors 50, thereby causing X-ray “crosstalk” which lowers image contrast and resolution. More particularly, with Compton scattering, the X-ray produces scattered photons as well as recoil electrons, whereas with photocapture (i.e., the photoelectric effect), the X-ray produces excited electrons, but does not produce scattered photons. So with the higher energy X-ray producing increased Compton scattering, more scattered photons are produced and the scattered photons (from the increased Compton effect) may enter adjacent detectors, thereby creating “crosstalk” with neighboring detectors.

At X-ray energies above approximately a few MeV, the detector efficiencies drop very low, with reasonable scintillator thickness, and X-ray “crosstalk” is very high. At these energy levels, the dominant interaction types are Compton scatter and electron-positron pair production.

By way of example but not limitation, for a scintillator made out of a material having a high atomic number Z (e.g., CdWO4) and having a 2 mm thickness (which would generally be considered “thick” for scintillators used in CT detector applications), there is a 6.1% probability of interaction with a photon at 10 MeV, while for a scintillator made out of Tungsten which is 2 mm thick, there is a 16.5% probability of interaction with a photon at 10 MeV.

Thus there is a need for a new and improved X-ray detector for use with high-energy X-ray beams which reduces X-ray “crosstalk” between adjacent detectors.

### SUMMARY OF THE INVENTION

The present invention comprises the provision and use of a new and improved X-ray detector for use with high-energy X-ray beams which reduces X-ray “crosstalk” between adjacent detectors.

In one preferred form of the invention, there is provided a detector for detecting X-rays passing through an object being scanned, the detector comprising:
a converter configured to convert X-rays into electrons;
a scintillator configured to detect electrons from the converter and produce light in proportion to the electrons detected; and
a photodetector configured to convert the light produced by the scintillator into electrical current.

In another preferred form of the invention, there is provided a detector for detecting X-rays passing through an object being scanned, the detector comprising:
a converter configured to convert X-rays into electrons; and
a direct electron detector configured to detect electrons from the converter and produce electrical current in proportion to the electrons detected.

In another preferred form of the invention, there is provided a method for scanning an object, the method comprising:
providing apparatus comprising:
   an X-ray source for emitting a beam of X-rays along an emission path;
   a detector comprising:
   a converter configured to convert X-rays into electrons;
   a scintillator configured to detect electrons from the converter and produce light in proportion to the electrons detected; and
   a photodetector configured to convert the light produced by the scintillator into electrical current; and
disposing an object to be scanned between the X-ray source and the detector, such that the emission path passes through the object.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-3 are schematic views showing an exemplary CT machine which may be used to scan an object;

FIG. 4 is a schematic view showing an exemplary detector array comprising a plurality of detectors;

FIG. 5 is a schematic view showing an exemplary prior art detector;

FIG. 6 is a schematic view showing a novel detector formed in accordance with the present invention;

FIG. 7 is a schematic view showing further embodiments of the novel detector of FIG. 6; and

FIG. 8 is a schematic view showing another novel detector formed in accordance with the present invention.

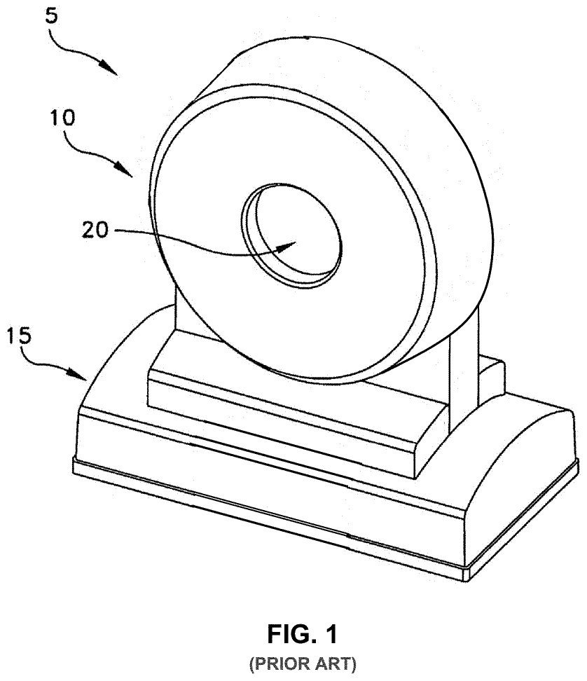

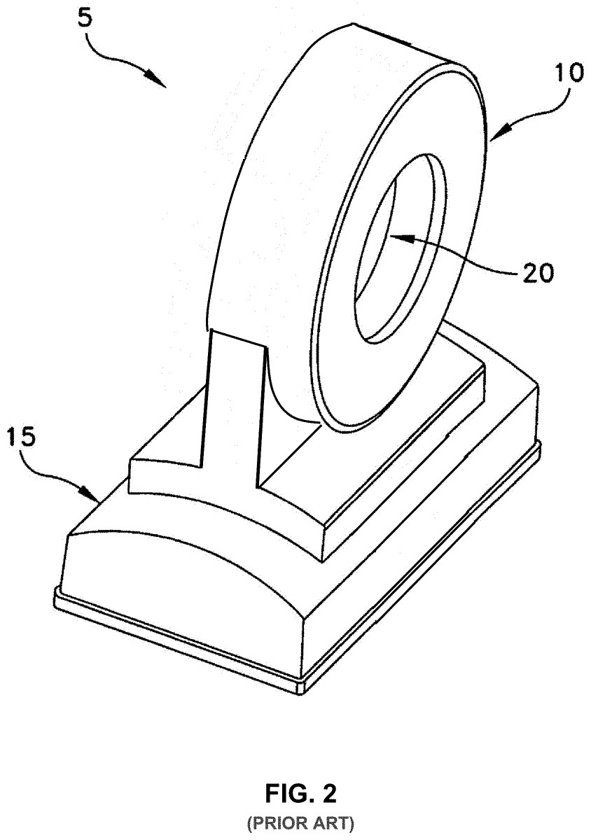

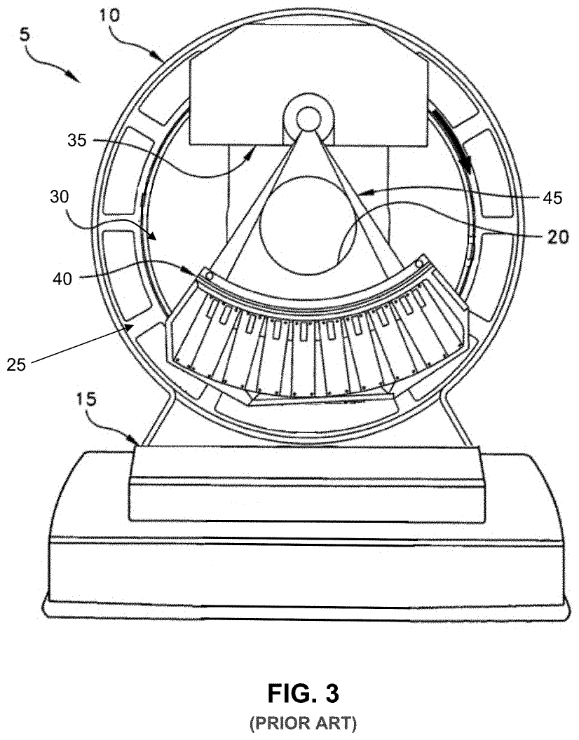

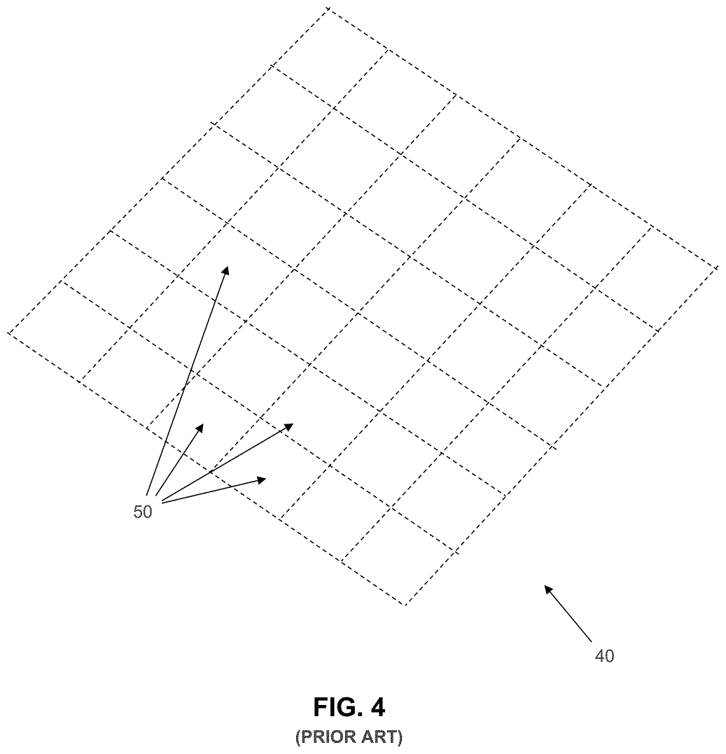

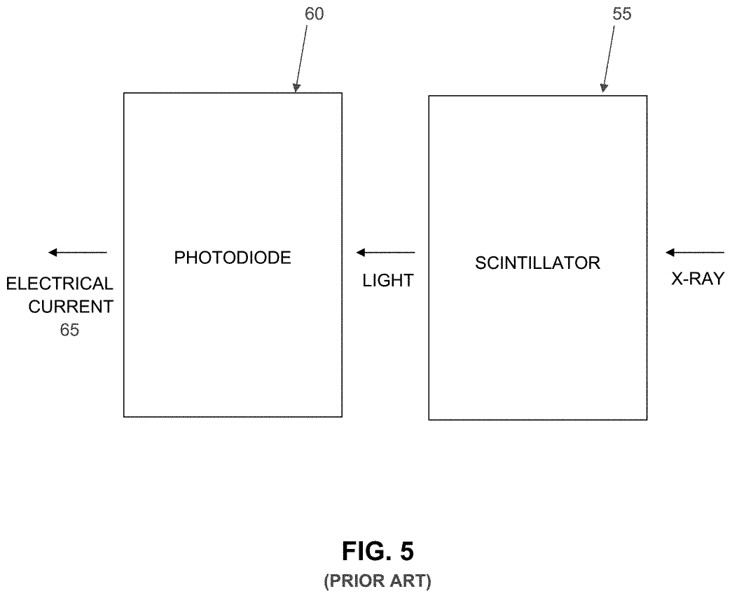

### DETAILED DESCRIPTION OF THE PREFERRED EMBODIMENTS

The present invention comprises the provision and use of a new and improved X-ray detector for use with high-energy X-rays which reduces X-ray “crosstalk” between adjacent detectors.

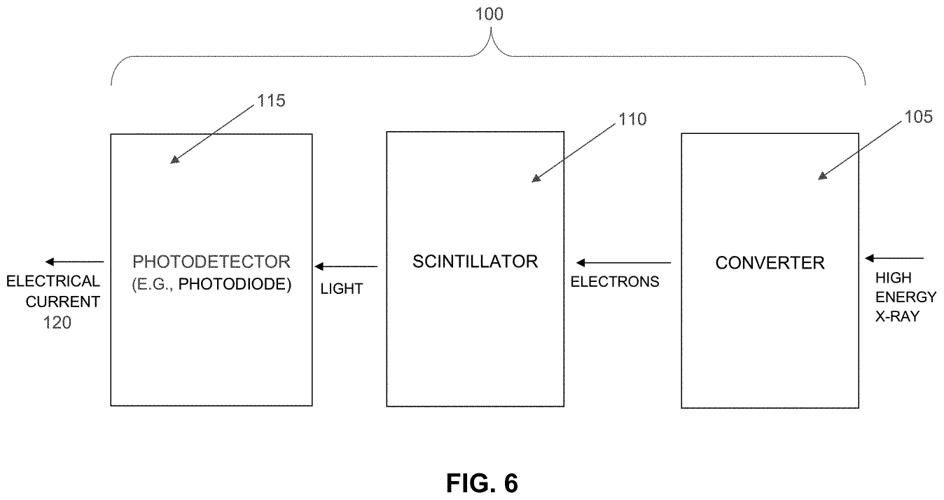

More particularly, and looking now at FIG. 6, the present invention generally comprises a detector 100 comprising a converter 105 configured to convert high energy X-rays into Compton recoil electrons and pair production electrons that escape from converter 105, a scintillator 110 configured to detect the electrons escaping from converter 105 and produce light in proportion to the escaping electrons, and a photodetector 115 configured to convert the light emitted from scintillator 110 into electrical current 120. As a result of this construction of detector 100, it will be appreciated that electrical current 120 produced by photodetector 115 is representative of the amount of X-rays received by converter 105.

The thickness of converter 105 is chosen by considering the trade-off between (i) Compton scatter and pair production efficiency (which increases as the thickness of converter 105 increases), and (ii) the probability of electron escape (which decreases as the thickness of converter 105 increases).

In one preferred form of the present invention, converter 105 comprises a high-Z metal (e.g., tungsten, lead or copper), and converter 105 is formed with a thickness of approximately 2 mm in order to balance the probability of (i) Compton scatter and pair production, with (ii) recoil electron escape. That is, converter 105 is preferably formed so as to be thick enough to provide substantial Compton scatter and pair production, but not so thick as to cause the electrons to have difficulty escaping from converter 105.

It will be appreciated that the provision of detector 100 comprising a converter 105 configured to convert high energy X-rays into Compton recoil electrons and pair production electrons that escape from converter 105, and scintillator 110 configured to detect the electrons escaping from converter 105 (to produce light in proportion to the escaping electrons) offers numerous advantages over prior art detectors such as the exemplary prior art detector 50 discussed above.

More particularly, the use of converter 105 in detector 100 is more efficient for X-ray interaction than use of a scintillator alone (i.e., such as with the prior art detector 50 comprising a scintillator element 55 discussed above). Scintillator 110 is more efficient for detecting electrons (i.e., because the electrons are charged) than for detecting high energy photons (such as would occur when using a prior art detector 50 in which the scintillator element 55 interacts directly with photons contained in X-ray beam 45). This is because there is essentially 100% efficiency in scintillator 110 when detecting electrons escaping from converter 105.

Furthermore, due to interaction between the electrons escaping from converter 105 and scintillator 110 being governed by the derivative dE/dx (i.e., change in energy over distance travelled), electrons above a certain energy threshold will all deposit similar energy in a thin, low-Z (i.e., low atomic number) scintillator 110 before escaping out of the back of scintillator 110. Thus it will be appreciated that, with the novel detector 100 of the present invention, scintillator 110 can be made of a material with a low atomic number, and scintillator 110 can be made much thinner than prior art scintillators (e.g., scintillator 55 discussed above), which prior art scintillators must be very thick when used with high-energy X-ray beams. And, as a result of this construction, novel detector 100 is able to avoid the issues (e.g., Compton scattering) inherent in using high-energy X-ray beams with prior art detectors, thereby essentially eliminating X-ray “crosstalk”.

Stated another way, since scintillator 110 is preferably made of a thin, low-Z material, scintillator 110 is almost immune to “pollution” from direct detection of high energy photons (e.g., “pollution” which arises from the photo pollution from X-rays passing through scintillator 55). Hence, the only signal that is picked up by scintillator 110 is from the electrons escaping from converter 105.

Additionally, since scintillator 110 is made of a thin, low-Z material, scintillator 110 is more immune to several radiation damage mechanisms inherent in the use of high energy X-ray beams.

It will also be appreciated that a thin, low-Z scintillator such as the scintillator 110 of the present invention is less expensive than the thick, high-Z scintillator which would be necessary for high efficiency of detection when using prior art detectors such as detector 50 discussed above (i.e., prior art detectors in which a scintillator is configured to detect high energy X-rays passing through the scintillator).

Furthermore, with the novel detector 100 of the present invention, more light is produced in scintillator 110 by electron transit than would be produced by photon interaction. Larger light output expands electronics options, and makes the system more immune to electronic noise.

Thus it will be seen that with the detector 100 of the present invention, converter 105 is used to convert high energy X-rays emitted in a high-energy X-ray beam into electrons (i.e., from Compton scatter and pair production in the converter) that escape from converter 105, scintillator 110 is used to detect the recoil electrons received from converter 105 and produce corresponding light, and photodetector 115 (i.e., a photodiode) is used to convert that light into electrical current.

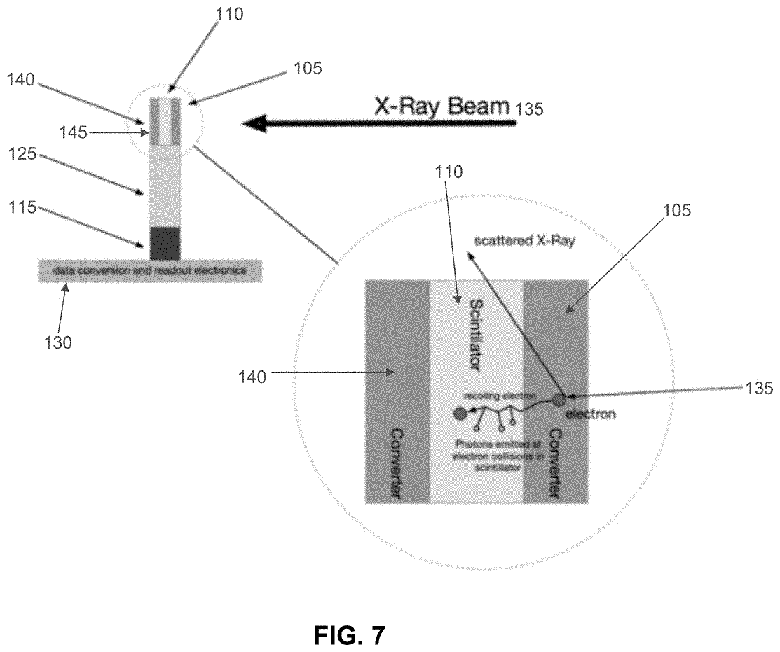

If desired, and looking now at FIG. 7, a side readout light guide 125 can be used to move the electronics out of the path of the X-ray beam. More particularly, a right-angle light guide 125 may be provided so that data conversion and readout electronics 130 are located out of the path of an X-ray beam 135. As a result of this construction, data conversion and readout electronics 130 are less susceptible to distortion and/or damage from the high energy X-rays present in X-ray beam 135. If desired, a reflector (not shown) may be disposed on the top surface of scintillator 110 to reflect light back into scintillator 110 and then into light guide 125, whereby to increase efficiency of detector 100.

Additionally, if desired, a backscatter converter 140 (FIG. 7) can be disposed on the far side of scintillator 110 (i.e., the side of scintillator 110 disposed furthest away from converter 105) for added efficiency. More particularly, some of the high energy X-rays in X-ray beam 135 will pass through converter 105, and then will also pass through scintillator 110. When such X-rays then pass into backscatter converter 140, some of these X-rays will interact with backscatter converter 140 and generate additional electrons in the backscatter converter. The electrons generated in backscatter converter 140 will then also pass into scintillator 110, thereby increasing efficiency of detector 100.

And, if desired, an electron shield 145 (i.e., any substantial piece of metal) can be disposed on the far side of backscatter converter 140 (i.e., the side of backscatter converter 140 disposed furthest away from scintillator 110) so as to prevent electrons from leaving the back side of detector 100 (which escaping electrons could otherwise adversely interact with other equipment of the CT machine.

### Alternative Detector

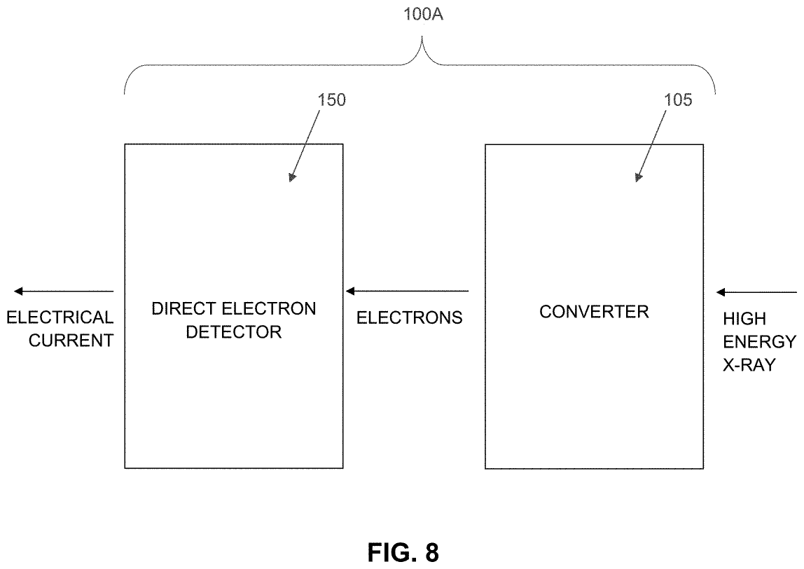

Looking now at FIG. 8, in an alternative form of the present invention, there is provided an alternative detector 100A. With alternative detector 100A, scintillator 110 and photodetector 115 are replaced by a direct electron detector 150.

With alternative detector 100A, a high-energy X-ray enters converter 105, where the X-rays are converted into Compton recoil electrons and pair production electrons that escape from converter 105, and the electrons that escape from converter 105 are detected by direct electron detector 150 (whereby to produce electrical current representative of the amount of X-rays entering converter 105).

With this alternative form of the present invention, the overall cost of detector 100A can be significantly reduced, since detector 100A eliminates the cost of the scintillator and photodiode. However, it will be appreciated that detector 100A disposes direct electron detector 150 in the path of the high energy X-ray beam, where it may be damaged by the high energy X-rays.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A detector for detecting X-rays passing through an object being scanned, the detector comprising:
a converter configured to convert X-rays into electrons;
a scintillator configured to detect electrons from the converter and produce light in proportion to the electrons detected; and
a photodetector configured to convert the light produced by the scintillator into electrical current.

2. A detector according to claim 1 wherein the X-rays have an energy greater than approximately 140 keV.

3. A detector according to claim 1 wherein the photodetector comprises a photodiode.

4. A detector according to claim 1 wherein the converter is configured to convert X-rays into at least one selected from the group consisting of Compton recoil electrons and pair production electrons.

5. A detector according to claim 1 wherein the converter comprises a material having a high atomic number, and wherein the scintillator comprises a material having a low atomic number.

6. A detector according to claim 5 wherein the material having a high atomic number comprises one selected from the group consisting of tungsten, lead and copper.

7. A detector according to claim 1 wherein the converter is approximately 2 mm in thickness in the dimension parallel to the incidence of the X-rays directed at the converter.

8. A detector according to claim 1 wherein the detector further comprises a backscatter converter, wherein the converter is disposed closer to a source of the X-rays than the scintillator, wherein the scintillator is disposed closer to the source of the X-rays than the photodetector, and wherein the backscatter converter is disposed further away from the source of the X-rays than the photodetector.

9. A detector according to claim 1 further comprising an electron shield, wherein the converter is disposed closer to a source of the X-rays than the scintillator, wherein the scintillator is disposed closer to the source of the X-rays than the photodetector, and wherein the electron shield is disposed further away from the source of the X-rays than the photodetector.

10. A detector for detecting X-rays passing through an object being scanned, the detector comprising:
a converter configured to convert X-rays into electrons; and
a direct electron detector configured to detect electrons from the converter and produce electrical current in proportion to the electrons detected.

11. A method for scanning an object, the method comprising:
providing apparatus comprising:
an X-ray source for emitting a beam of X-rays along an emission path;
a detector comprising:
a converter configured to convert X-rays into electrons;
a scintillator configured to detect electrons from the converter and produce light in proportion to the electrons detected; and
a photodetector configured to convert the light produced by the scintillator into electrical current; and
disposing an object to be scanned between the X-ray source and the detector, such that the emission path passes through the object.

12. A method according to claim 11 wherein the X-rays have an energy greater than approximately 140 keV.

13. A method according to claim 11 wherein the photodetector comprises a photodiode.

14. A method according to claim 11 wherein the converter is configured to convert X-rays into at least one selected from the group consisting of Compton recoil electrons and pair production electrons.

15. A method according to claim 11 wherein the converter comprises a material having a high atomic number, and wherein the scintillator comprises a material having a low atomic number.

16. A method according to claim 15 wherein the material having a high atomic number comprises one selected from the group consisting of tungsten, lead and copper.

17. A method according to claim 11 wherein the converter is approximately 2 mm in thickness in the dimension parallel to the incidence of the X-rays directed at the converter.

18. A method according to claim 11 wherein the detector further comprises a backscatter converter, wherein the converter is disposed closer to a source of the X-rays than the scintillator, wherein the scintillator is disposed closer to the source of the X-rays than the photodetector, and wherein the backscatter converter is disposed further away from the source of the X-rays than the photodetector.

19. A method according to claim 11 further comprising an electron shield, wherein the converter is disposed closer to a source of the X-rays than the scintillator, wherein the scintillator is disposed closer to the source of the X-rays than the photodetector, and wherein the electron shield is disposed further away from the source of the X-rays than the photodetector.

20. A method according to claim 11 further comprising processing the electrical current produced by the photodetector so as to create a 3D data set of the object and a 3D computer model of the object.
